(19) United States
(12) Patent Application Publication
(10) Pub. No.: US 2007/0127036 A1
(43) Pub. Date: Jun. 7, 2007

(54) Interference measurement system self-alignment method

(75) Inventors: Chien-Chong Liao, Taou-Yuan Hsien (TW); Yao-Min Lin, Taou-Yuan Hsien (TW); Huang-Chang Chang, Taou-Yuan Hsien (TW); Wei-Che Chang, Taou-Yuan Hsien (TW)

Correspondence Address: BIRCH STEWART KOLASCH & BIRCH, PO BOX 747, FALLS CHURCH, VA, 22040-0747, US

(73) Assignee: Chroma Ate Inc., Taoyuan Hsien (TW)

(21) Appl. No.: 11/295,672

(22) Filed: Dec. 7, 2005

(51) Int. Cl. G01B 11/02

(52) U.S. Cl. 356/512

(57) ABSTRACT

An interference measurement system self-alignment method, which can be realized through an optical image interference measurement system. The method comprises the following steps of: utilizing the imaging device to get the optical information of the object to be measured and store the optical information thus obtained; performing the inclination adjustment of the first direction rotation axis of the object platform based on the direction of the interference fringe in the optical information until the interference fringes are adjusted to a defined orthogonal direction, thus eliminating the inclination of the first direction rotation axis; and performing the inclination adjustment of the second direction rotation axis of the object platform based on the expansion direction of the interference fringe in the optical information until the spacing of the interference fringes are adjusted to the maximum, thus eliminating the inclination of the second direction rotation axis.

### BACKGROUND OF THE INVENTION

1. Field of the Invention

The present invention relates to a self-alignment method used in an interference measurement system, and in particular to a self-alignment method used in an imaging device, so that the inclination angle between the optical axis of an imaging device and an object to be measured can be eliminated or at least reduced significantly, so as to improve the accuracy of measurement and the effectiveness of the imaging device.

2. The Prior Arts

In general, an interference measurement system, and in particular, a white light interference measurement system is used to measure the surface profile of a micro-structure. To increase the accuracy of measurement and the effectiveness of the white light interference measurement system, the effect of inclination angle of the object to be measured relative to the interference system must be considered. Usually, in the implementation of this kind of measurement technology, the scan range, the scan duration, and the measurement accuracy are the most important factors to be considered.

In the implementation of interference measurement system, in case an inclination angle exists between a normal line of the object and an optical axis of the interference measurement system, the scan range and the scan duration will have to be increased correspondingly. However, in case that the surface of the object is perpendicular to the optical axis of the system, then the interference measurement system utilizing the Vertical Scanning Interface (VSI) technology needs only to define the width of the wave packet area as the range of scan. Yet, in case an inclination angle exists between the surface of the object to be measured and the optical axis of the interference measurement system, then the scanning range must be increased correspondingly, so as to be able to include all the interferograms of the object. As such, much more images of various heights must be obtained, thus be able to calculate and produce a 3-D profile of the object to be measured. Moreover, the time required for the measurement also increases correspondingly, thus reducing its applicability in the industry significantly.

Furthermore, in the prior art, an interference measurement system is utilized to perform the vertical scanning of an object, thus producing its 3-D profile. In case that the scan range comprises only the interferograms, thus the noises coming from outside the range is reduced to the minimum, then the measuring system could have better accuracy in determining the central position of the wave packets, thus the measurement errors are reduced. In other words, in case that the scan range is too large, thus the interferograms scanned represent only a portion of all the waves scanned by the system, and the majority of the waves scanned are predominantly noise. As such, the inclusion of too much undesirable noise would adversely affect the accuracy in determining the central position of the wave packets, thus resulting in the deviation of the central position and the increase of measurement errors of the interference measurement system.

In view of the afore-mentioned analyses, it is evident that the inclination angle of the object to be measured could have enormous influence on the accuracy and effectiveness of the interference measurement system, and thus affecting its applicability in the industry. However, presently, the adjustment of the inclination angle of the object is done manually, and the determination of the inclination angle and its subsequent adjustment depend mostly on the experience of the user. Thus, the inexperience of the user or the inaccurate determination of the inclination angle due to the unusual profile of the object's surface, both could result in the consequence that, the inclination of the object can not be accurately reduced or eliminated. As such, the accuracy and reproducibility of the manual determination and adjustment of the inclination angle of the object are very much in doubt.

Therefore, the research and development of an interference measurement system self-alignment method, thus achieving a simple, speedy and accurate measurement of the object, is the most urgent task in this field.

### SUMMARY OF THE INVENTION

Therefore, the objective of the present invention is to provide a self-alignment method used in an interference measurement system, which is utilized to replace the conventional inclination angle manual adjustment method, wherein the direction and spacings of the interference fringes of the image of the object are used to determine and eliminate the inclination of the object and raise the accuracy of the measurement of the object, as such avoiding the necessity of including all the interferograms produced, since that would make the measuring range overly large, and unnecessarily prolong the measuring duration, due to the over-inclination of the object to be measured.

The another objective of the invention is to provide an interference measurement system self-alignment method, that is used to determine the inclination of the object to be measured based on the direction and spacings of the interference fringes of the image of the object, and proceed with the adjustment of the inclination of the object, thus realizing the objective of reducing the scan range of the interference measurement system, raising the accuracy of the measurement and reducing the scan duration.

The yet another objective of the present invention is to provide an interference measurement system self-alignment method, that can be used to accurately determine and eliminate the inclination of the object to be measured, even if the surface of the object is provided with regular undulations.

In view of the various afore-mentioned objectives, the present invention provides an interference measurement system self-alignment method, that is realized by making use of an optical image interference measurement system, including: a light source, a set of object lenses, a light beam guidance device, an imaging system, a logic-arithmetic-control unit, and an object platform, wherein, the object platform is controlled by a plurality of axes, and is composed of two orthogonal first direction rotation axis and second direction rotation axis and their control device; the method comprises the following steps: utilizing the fetching device to fetch the optical information of the object to be measured and storing the information thus obtained; performing the inclination adjustment of the object platform in the first direction rotation axis based on the direction of the interference fringe in the optical image, until the interference fringes are adjusted to a defined orthogonal direction, thus eliminating the inclination of the object in the first direction rotation axis; and performing the inclination adjustment of the object platform in the second direction rotation axis based on the direction of expansion of the interference fringes in an optical image, until the spacing between the interference fringes is expanded to its maximum, thus eliminating the inclination of the object in the second direction rotation axis

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic diagram of the an interference measurement system utilized in the self-alignment method according to an embodiment of the present invention;

FIG. 2 is a flowchart of the steps of the interference measurement system self-alignment method according to an embodiment of the present invention;

FIGS. 3 & 4 are the schematic diagrams indicating the variations of the interference fringes during the inclination adjustment of the first direction rotation axis utilized in the interference measurement system self-alignment method according to an embodiment of the present invention;

FIGS. 5A to 5C are the schematic diagrams of the region growth of the gray level bar chart distribution utilized in the interference measurement system self-alignment method according to an embodiment of the present invention;

FIGS. 6 to 8 are the schematic diagrams indicating the variations of the interference fringes during the inclination adjustment of the second direction rotation axis utilized in the interference measurement system self-alignment method according to an embodiment of the present invention; and

FIG. 9 is a schematic diagram indicating the variations of the interference fringes during the inclination adjustment of the second direction rotation axis for an object to be measured having rough surface as utilized in the interference measurement system self-alignment method according to an embodiment of the present invention.

### DETAILED DESCRIPTION OF THE PREFERRED EMBODIMENT

The purpose, construction, features, and functions of the present invention can be appreciated and understood more thoroughly through the following detailed description with reference to the attached drawings.

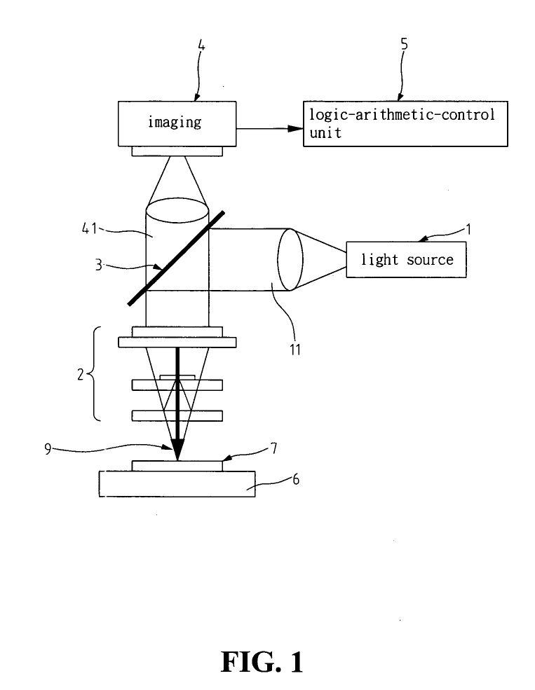

Firstly, referring to FIG. 1 for a schematic diagram of the an interference measurement system utilized in the self-alignment method according to an embodiment of the present invention. As shown in FIG. 1, the interference measurement system of the present invention includes: a light source 1, a set of object lenses 2, a light beam guidance device 3, an imaging system 4, a logic-arithmetic-control unit 5, and an object platform 6. Wherein the light source 1 is used to generate incident light beam 11 of white light signal; the set of object lenses 2 is composed of an interference object lens and a focal length adjustment means; the light beam guidance device 3 is an optical device, which is used to guide the light signal emitted from the light source of the system, and it may be, for example, a light splitter; the imaging device 4 is an optical device having an imaging means, and it may be, for example, a CCD or CMOS photo-sensing device and its related control and signal transmission circuit; the logic-arithmetic-control-unit 5 is composed of a logic-arithmetic means, a memory means, and a control means, and it may be realized through an electronic circuit or a computer system; the object platform 6 is controlled by a plurality of axes, for example, it may be composed of two mutually perpendicular rotation axes and the related control device, and the two perpendicular rotation axes include a first direction rotation axis and a second direction rotation axis. In the following, the implementation of the interference measurement system self-alignment method of the present invention will be described in detail. Firstly, a light beam 11 emitted from the light source 1 is reflected to a set of object lenses 2 through the light beam guidance device 3, so that the incident light beam 11 reaches the object 7 to be measured and is reflected to form a reflected light beam 41 having the interference signals, and after passing through a set of object lenses 2, the reflected light beam 41 penetrates through the light beam guidance device 3 and is received by the imaging device 4. As such, the logic-arithmetic-control unit 5 may be used to proceed with adjusting the alignment plane of the object platform 6, and store the optical information obtained by the imaging device 4, so that the interference measurement system self-alignment method of the present invention may be used to perform calculation on the optical information thus obtained to realize the optimum adjustment of the alignment plane by making use of the logic-arithmetic means of the logic-arithmetic-control unit 5.

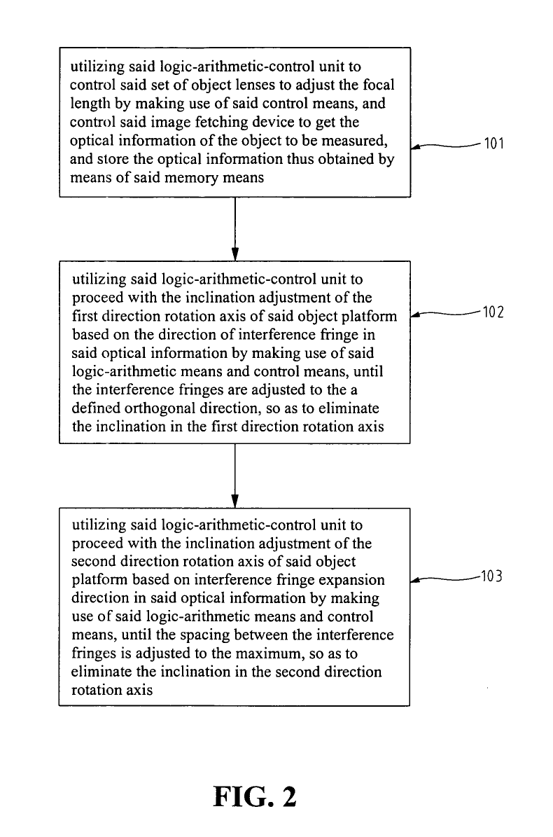

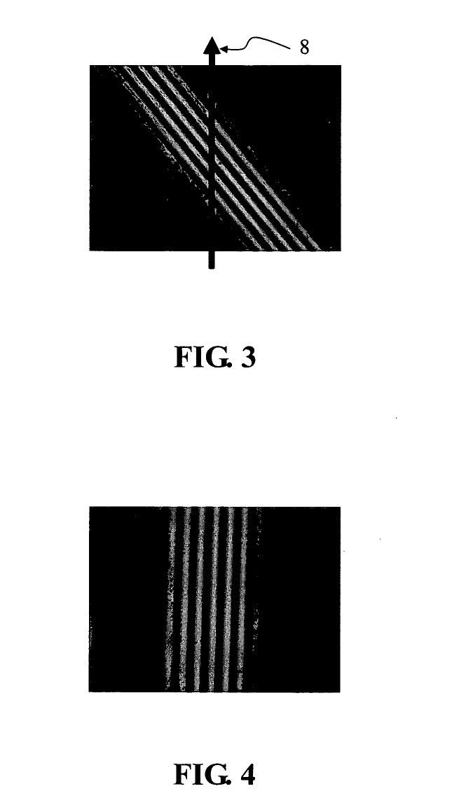

Next, referring to FIG. 2 for a flowchart of the steps of the interference measurement system self-alignment method according to an embodiment of the present invention. Also, referring to FIGS. 3 and 4 for the schematic diagrams of the variations of interference fringes during the inclination adjustment of the first direction rotation axis according to an embodiment of the invention. As shown in FIG. 2, the interference measurement system self-alignment method of the present invention includes the following steps. Firstly, utilizing the control means of the logic-arithmetic-control unit 5 to control the set of object lenses 2 for adjusting its focal length, and control the imaging device 4 in fetching the optical information of the object 7, and store the optical information thus obtained through the memory means (step 101). Then, utilizing the logic-arithmetic means and the control means of the logic-arithmetic-control unit 5 to proceed with the inclination adjustment of the first direction rotation axis of the object platform 6 based on the direction of the interference fringes in the optical image, until the interference fringes are adjusted to a defined orthogonal direction, thus eliminating the inclination of the first direction rotation axis (step 102), And finally, utilizing the logic-arithmetic means and the control means of the logic-arithmetic-control unit 5 to proceed with the inclination adjustment of the second direction rotation axis of the object platform 6 based on the expansion direction of the interference fringes in the optical image, until the spacing of interference fringes are adjusted to the maximum, thus eliminating the inclination of the second direction rotation axis (step 103).

In the above description, the amount of inclination is defined as the angle between an optical axis 9 along the direction of light beam 11 propagation and the surface of the object 7 to be measured.

In the afore-mentioned inclination adjustment of the first direction rotation axis, it can further be divided into the steps of the first direction rotation axis gross search and first direction rotation axis minute search, which will be described in detail as follows. In the first direction rotation axis gross search, the inclination adjustment is conducted based on the variations in the orthogonal direction. Firstly, the imaging device 4 is used to fetch images at the starting position to obtain the image as shown in FIG. 3. Next, the logic-arithmetic-control unit 5 is used to calculate the value of an inclination adjustment function of the first direction rotation axis based on the gray level variations of the image information. Then, the logic-arithmetic-control unit 5 is used to control the object platform 6 to make a slight rotation in a specific direction relative to the first direction rotation axis, and recalculate the value of the inclination adjustment function in that position, and then determine the decrementing direction of the inclination adjustment function of the first direction rotation axis based on the difference between the former and latter functional values thus calculated. And finally, logic-arithmetic-control unit 5 is used to control the object platform 6 to rotate and adjust continuously along the inclination adjustment function decrementing direction of the first direction rotation axis, meanwhile calculating the inclination adjustment function value at every step continuously until it reaches the position corresponding to the minimum value of the inclination adjustment function, and defining the position thus obtained as the position of minimum inclination. Then, this position of minimum inclination is used by the subsequent first direction rotation axis minute search as a basis to continue searching for the minimum inclination in a specific range at steps of smaller magnitude. Subsequently, the values of the inclination adjustment function calculated at every step in the first direction rotation axis minute search process is recorded until it reaches the minimum value. Then, the data of these functional values are fitted through a quadratic equation curve to obtain the minimum inclination value of the first direction rotation axis, and the optical image of which is as shown in FIG. 4.

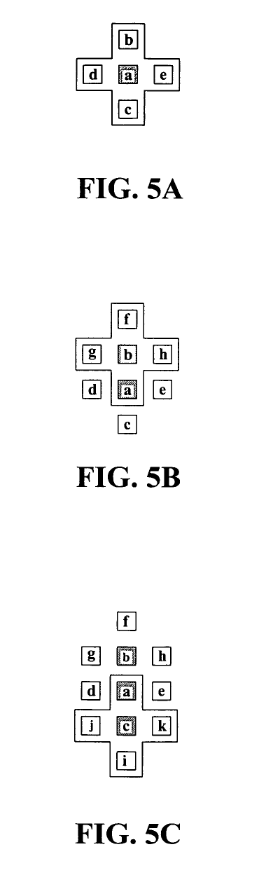

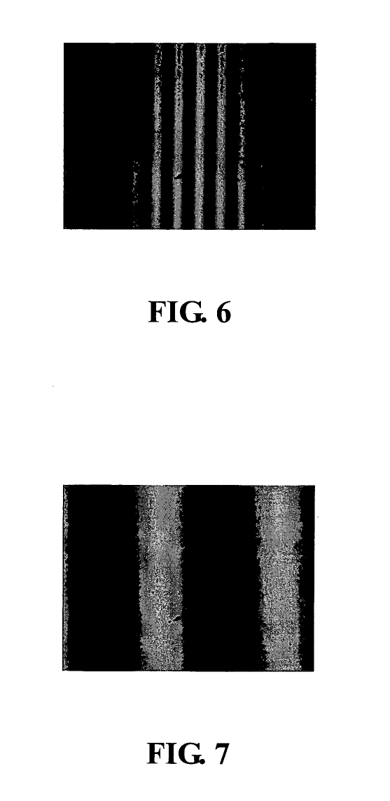

Furthermore, referring to FIGS. 5A to 5C for the schematic diagrams of the region growth of the gray level bar chart distribution utilized in the interference measurement system self-alignment method according to an embodiment of the present invention. Also, referring to FIGS. 6 to 8 for the schematic diagrams indicating the variations of the interference fringes during the inclination adjustment of the second direction rotation axis utilized in the interference measurement system self-alignment method according to an embodiment of the present invention. In the inclination adjustment of the second direction rotation axis, the adjustment is realized based on the width of spacing between the interference fringes, wherein the width of the spacing is adjusted to the maximum to achieve the elimination of inclination of the second direction rotation axis. In the inclination adjustment of the second direction rotation axis, the adjustment process can further be divided into the steps of the second direction rotation axis gross search and second direction rotation axis minute search, which will be described in detail as follows. In the second direction rotation axis gross search, the wider the spacing between the interference fringes the smaller the inclination of the second direction rotation axis, and that is used as the guiding principle in seeking the second direction rotation axis adjustment direction corresponding to the increase of interference fringe spacing. In an embodiment of the present invention, the Optical Flow technology is utilized to determine the inclination direction of the second direction rotation axis of the object platform 6 on which the object 7 to be measured is placed, then inclination adjustment is performed toward diminishing inclination through specific steps, meanwhile the values of the inclination adjustment function of the second direction rotation axis is calculated for the respective steps, and the maximum value of the function thus obtained corresponds to the position of minimum inclination of the second direction rotation axis. In the above analysis, firstly, the inclination adjustment function of the second direction rotation axis is used to find the position corresponding to the zero order interference fringe as the seeding point as shown in FIG. 5A. Then, a specific fixed boundary condition is set to calculate the region growth area of the gray level value bar chart distribution as the function value, as shown in FIGS. 5B to 5C. In the inclination adjustment process of the second direction rotation axis, the larger the region growth area, the smaller the inclination of the second direction rotation axis as shown in FIGS. 6 and 7, until a single interference fringe covers the entire scope of the image. As such, the curve of the inclination adjustment function of the second direction rotation axis is such a curve that it has the maximum value at a single peak, which corresponds to the position of minimum inclination of the second direction rotation axis.

Subsequently, the vicinity of the maximum value of the inclination adjustment function of the second direction rotation axis gross search is set as the searching range of the second direction rotation axis minute search, and the search is conducted in such a manner that the magnitude of step of the second direction rotation axis minute search is smaller than that of the first direction rotation axis gross search, and the gray level bar chart distribution of the respective search steps are recorded. In the present process, the calculation of the value of the inclination adjustment function is replaced with the calculation of gray level bar chart distribution area, its purpose is mainly to raise the resolution of the interference measurement system, and to avoid the possibility that the size of the region growth area would be affected by the mixed point of the body to be measured at the position of minimum inclination. In the process of adjustment, the minimum value of the gray level bar chart distribution corresponds to the position of the minimum inclination of the second direction rotation axis. As such, the inclination of the object 7 to be measured is adjusted and reduced to the minimum, thus a single interference fringe covers the entire range of the optical image due to the expansion of the spacings the interference fringes for the object 7 to be measured, so that the image in an image sensor indicates an entire white or entire black image as shown in FIG. 8.

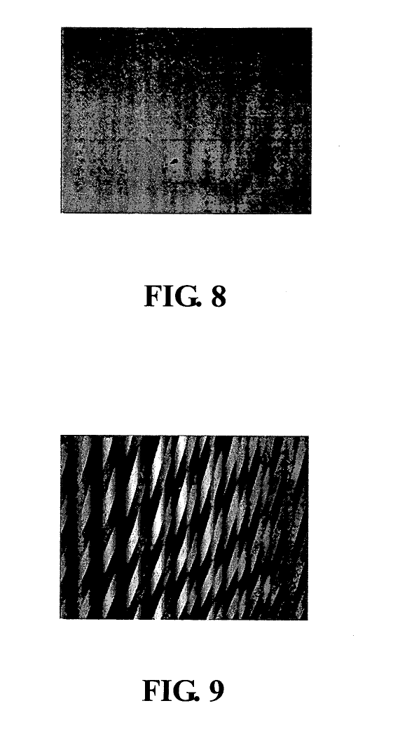

Finally, referring to FIG. 9 for a schematic diagram of the interference fringes during the inclination adjustment of the second direction rotation axis for the object to be measured having rough surface according to an embodiment of the invention. In the afore-mentioned interference measurement system self-alignment method, the object 7 to be measured having a smooth surface is taken as an example. However, in case that the object 7 to be measured is an object having rough surface, then in the process of inclination adjustment of the second direction rotation axis, the smaller the spacing between the interference fringes the smaller the inclination of the second direction rotation axis, and that is used a basis in determining and proceeding with the inclination adjustment of the second direction rotation axis until the optical image is full of evenly and densely spaced interference fringes as shown in FIG. 8, wherein the minimum value of the inclination adjustment function of the second direction rotation axis corresponds to the position of minimum inclination of the second direction rotation axis. In addition, the vicinity of the minimum value of the inclination adjustment function of the second direction rotation axis gross search is set as the searching range of the second direction rotation axis minute search, and the gray level bar chart distribution of the respective search steps are recorded. In this instance, in the second direction rotation axis minute search, the calculation of the values the inclination adjustment function is replaced by the calculation of the gray level bar chart distribution area, thus the maximum value of gray level bar chart distribution corresponds to the minimum inclination of the second direction rotation axis.

The above detailed description of the preferred embodiment is intended to describe more clearly the characteristics and spirit of the present invention. However, the preferred embodiments disclosed above is not intended to be any restrictions to the scope of the present invention. Conversely, its purpose is to include the various changes and equivalent arrangements which are within the scope of the appended claims.

What is claimed is:

1. An interference measurement system self-alignment method, comprising the following steps:
providing an optical image system including: a light source, a set of object lenses, a light beam guidance device, an imaging device, a logic-arithmetic-control unit, and an object platform, wherein the light source is used to generate a light source signal of incident light beam; said set of object lenses includes a interference object lens and a focal length adjustment means; said light beam guidance device is an optical mechanism for guiding the light source signal; said imaging device is an optical device having an imaging means; said logic-arithmetic-control unit is provided with a logic-arithmetic means, a memory means, and a control means; and said object platform is controlled by a plurality of axes;
selecting said object platform as having two orthogonal rotation axes and its related control device, said orthogonal rotation axes includes a first direction rotation axis and a second direction rotation axis;
utilizing said logic-arithmetic-control unit to control said set of object lenses to adjust the focal length by making use of said control means, and control said imaging device to get the optical information of the object to be measured, and store the optical information thus obtained by means of said memory means;
utilizing said logic-arithmetic-control unit to proceed with the inclination adjustment of the first direction rotation axis of said object platform based on the direction of interference fringe in said optical information by making use of said logic-arithmetic means and control means, until the interference fringes are adjusted to a defined orthogonal direction, so as to eliminate the inclination in the first direction rotation axis; and
utilizing said logic-arithmetic-control unit to proceed with the inclination adjustment of the second direction rotation axis of said object platform based on interference fringe expansion direction in said optical information by making use of said logic-arithmetic means and control means, until the spacing between the interference fringes is adjusted to the maximum, so as to eliminate the inclination in the second direction rotation axis.

2. The interference measurement system self-alignment method as claimed in claim 1, wherein the step of adjusting the inclination in the first direction rotation axis includes further the following steps:
the first direction rotation axis gross search step, including:
utilizing said imaging device to get the images at the starting position to obtain the image information according to the variations in the orthogonal direction as basis for inclination adjustment;
utilizing said logic-arithmetic-control unit to calculate the inclination adjustment function of the first direction rotation axis, which is made by making use of the gray level variations of the image information of the image fetched;
utilizing said logic-arithmetic-control unit to control said object platform to make a slight rotation in a specific direction relative to the first rotation axis, and recalculate the value of the inclination adjustment function at said position, and determine the decrementing direction of the inclination adjustment function based on the difference of the former and latter values of the inclination adjustment function; and
utilizing said logic-arithmetic-control unit to control said object platform to rotate and adjust continuously along the decrementing direction of the inclination adjustment function of the first direction rotation axis, calculate the values of the inclination adjustment function at the respective steps to determine the position of the first direction rotation axis corresponding to the minimum value of the inclination adjustment function, and define this position as the gross minimum inclination position.

3. The interference measurement system self-alignment method as claimed in claim 2, wherein the step of adjusting the inclination in the first direction rotation axis includes further the following steps:
the first direction rotation axis minute search step, including:
executing the minute search in a specific range through a smaller magnitude of step as based on a gross minimum inclination obtained in the first direction rotation axis gross search as a center; and
recording the values of the inclination adjustment function of the respective steps in the process of the first direction rotation axis minute search, then the recorded data is fitted through a quadratic equation curve, and the minimum value thus obtained corresponds to the minimum inclination position of the first direction rotation axis

4. The interference measurement system self-alignment method as claimed in claim 1, wherein the step of adjusting the inclination in the second direction rotation axis includes further the following steps:
the second direction rotation axis gross search step, including:
determining the inclination direction of the second direction rotation axis of the object platform on which the object to be measured is placed by making use of the Optical Flow technology;
performing the inclination adjustment in the direction of decrementing inclination through the steps of specific magnitude, and recording the values of direction rotation axis inclination adjustment function of the respective steps, and the maximum value thus obtained is the value required for the minimum inclination;
utilizing the inclination adjustment function of the second direction rotation axis to find zero order interference fringe in all the interference fringes as a seeding point, and setting fixed boundary condition to calculate the size of gray level bar chart distribution region growth area as the function value; and
selecting the maximum value of the inclination adjustment function of the second direction rotation axis, and defining said maximum value as the value corresponding to the minimum inclination position of the second direction rotation axis.

5. The interference measurement system self-alignment method as claimed in claim 4, wherein the step of adjusting the inclination in the second direction rotation axis includes further the following steps:
the second direction rotation axis minute search step, including:
executing the search by setting the magnitude of the step as less than that utilized in the second direction rotation axis gross search step;
setting the vicinity of the maximum value obtained in the second direction rotation axis gross search as the search range, and recording the gray level bar chart distributions of the respective search steps; and
selecting the minimum value of gray level bar chart distribution, and defining said minimum value as the value corresponding to the minimum inclination position of the second direction rotation axis.

6. The interference measurement system self-alignment method as claimed in claim 1, wherein the step of adjusting the inclination in the second direction rotation axis includes further the following steps:
the second direction rotation axis gross search step, including:
determining the inclination direction of the second direction rotation axis of the object platform on which the object to be measured is placed by making use of the Optical Flow technology;
performing the inclination adjustment in the direction of decrementing inclination through the steps of specific magnitude, and recording the values of second direction rotation axis inclination adjustment function of the respective steps, and the maximum value thus obtained is the value required for the minimum inclination;
utilizing the second direction rotation axis inclination adjustment function to find zero order interference fringe in all the interference fringes as a seeding point, and setting fixed boundary condition to calculate the size of gray level bar chart distribution region growth area as the function value; and
selecting the maximum value of the inclination adjustment function of the second direction rotation axis, and defining said maximum value as the value corresponding to the minimum inclination position of the second direction rotation axis.

7. The interference measurement system self-alignment method as claimed in claim 4, wherein the step of adjusting the inclination in the second direction rotation axis includes further the following steps:
the second direction rotation axis minute search step, including:
executing the search by setting the magnitude of the step as less than that utilized in the second direction rotation axis gross search step;
setting the vicinity of the minimum value obtained in the second direction rotation axis gross search as the search range, and recording the gray level bar chart distributions of the respective search steps; and
selecting the maximum value of gray level bar chart distribution, and defining said maximum value as the value corresponding to the minimum inclination position of the second direction rotation axis.

8. The interference measurement system self-alignment method as claimed in claim 1, further comprising the step of:
selecting said light source as a white light source generating an incident light beam of light signals

9. The interference measurement system self-alignment method as claimed in claim 1, further comprising the step of:
Selecting said light beam guidance device as a light splitter.

10. The interference measurement system self-alignment method as claimed in claim 1, further comprising the step of:
selecting said imaging device as any one of CCD or CMOS photo-sensing device.
